(19) United States
(12) Patent Application Publication
(10) Pub. No.: US 2026/0136156 A1
(43) Pub. Date: May 14, 2026

(54) SYSTEMS AND METHODS FOR REMOTE RENDERING, PRIVATE NETWORK, AND/OR DEVICE LOCALIZATION IN AN ENTERTAINMENT VENUE

(71) Applicant: Universal City Studios LLC, Universal City, CA (US)

(72) Inventor: Mo Raofi, Los Angeles, CA (US)

(21) Appl. No.: 19/384,803

(22) Filed: Nov. 10, 2025

Related U.S. Application Data
(60) Provisional application No. 63/838,350, filed on Jul. 3, 2025.
(60) Provisional application No. 63/718,429, filed on Nov. 8, 2024.
(60) Provisional application No. 63/718,456, filed on Nov. 8, 2024.

(51) Int. Cl. H04W 4/021; H04W 4/02

(52) U.S. Cl. CPC H04W 4/021; H04W 4/026

(57) ABSTRACT

A system for an entertainment venue includes a plurality of devices at the entertainment venue, at least one server remote from the plurality of devices, the entertainment venue, or both, where the at least one server is configured to perform a remote rendering task, and a private wireless network configured to facilitate data transmission between the plurality of devices and the at least one server.

### CROSS-REFERENCE TO RELATED APPLICATIONS

This application claims priority to and the benefit of U.S. Provisional Patent Application No. 63/718,456, entitled “REMOTE ARTIFICIAL INTELLIGENCE (AI), RENDERING, AND/OR DATA PROCESSING FOR DEVICES IN AN ENTERTAINMENT VENUE,” filed on November 8, 2024, U.S. Provisional Patent Application No. 63/718,429, entitled “HEAD-MOUNTED DISPLAY LOCALIZATION SYSTEM,” filed on November 8, 2024, and U.S. Provisional Patent Application No. 63/838,350, entitled “PRIVATE WIRELESS SYSTEMS AND METHODS,” filed on July 3, 2025, each of which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various devices employed in an entertainment venue (e.g., an amusement park), such as drones, smartphones, tablets, wearable devices (e.g., smart glasses, head-mounted displays (HMDs), virtual, augmented, and/or extended reality headsets, and the like), and the like include processing units configured to perform various tasks, such as image, video, and/or audio rendering tasks, artificial intelligence (AI) tasks, machine learning (ML) tasks, virtual reality (VR) and/or augmented reality (AR) output tasks, other data processing tasks, or any combination thereof. In certain configurations, the processing unit(s) and associated componentry (e.g., batteries and/or other hardware) may be onboard (e.g., physically integrated with) the device(s). Such configurations may undesirably contribute to a size and/or a weight of the device(s). Additionally or alternatively, traditional configurations configured to localize (e.g., determine a location and/or orientation of) such devices may be inaccurate and/or unreliable, which reduces a precision of image, video, and/or audio outputs from such devices, thereby negatively impacting an immersive experience of a user, may require excess computational loads, or both. Additionally or alternatively, traditional configurations may employ a network that communicatively couples at least some devices of the user(s) and/or the entertainment venue, but such networks in traditional configurations may not be adequately customized for and/or tailored to the immersive experiences desired for the users (e.g., guests) of the entertainment venue, may not be adequately protected from external interference, or both. Accordingly, it is now recognized that improved systems and methods are desired.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a system for an entertainment venue includes a plurality of devices at the entertainment venue, at least one server remote from the plurality of devices, the entertainment venue, or both, where the at least one server is configured to perform a remote rendering task, and a private wireless network configured to facilitate data transmission between the plurality of devices and the at least one server.

In an embodiment, a device localization system for an entertainment venue includes at least one sensor configured to acquire sensor data related to a device or an environment adjacent to the device, memory circuitry storing instructions thereon, and processing circuitry configured to execute the instructions to perform various functions. The functions include receiving the sensor data from the at least one sensor. The functions also include determining, based on a first localization technique, a region of the entertainment venue in which the device is disposed. The functions also include determining, based on a second localization technique different from the first localization technique, a location within the region of the entertainment venue at which the device is disposed, where the first localization technique, the second localization technique, or both are based at least in part on the sensor data.

In an embodiment, a method of operating an entertainment venue includes determining, via a first localization technique implemented by a device localization system, a general region and a general orientation of a device at the entertainment venue. The method also includes determining, via a second localization technique implemented by the device localization system, a specific location of the device within the general region and a specific orientation of the device within the general orientation. The method also includes rendering, via a server remote from the device and based at least in part on the specific location and the specific orientation, graphical content. The method also includes transmitting the graphical content from the server to the device.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an entertainment venue, such as an amusement park, including a remote rendering system, a private network (e.g., a private 5G wireless network), and a device localization system, according to embodiments of the present disclosure.

FIG. 2 is a perspective view of the entertainment venue of FIG. 1, the entertainment venue including various devices, such as drones, automated guided vehicles (AGVs), smartphones, tablets, wearable devices (e.g., smart glasses, head-mounted displays (HMDs), virtual, augmented, and/or extended reality headsets, and the like), according to embodiments of the present disclosure;

FIG. 3 is a schematic diagram of the entertainment venue of FIG. 1, the entertainment venue including the remote rendering system, the private network (e.g., the private 5G network), and the device localization system, according to embodiments of the present disclosure;

FIG. 4 is a schematic diagram of a processing and communication assembly of the entertainment venue of any of FIGS. 1-3, according to embodiments of the present disclosure;

FIG. 5 is a schematic diagram of the entertainment venue of FIG. 3, the entertainment venue further including an Internet network separate from the private network and configured to communicatively couple the remote rendering system with a plurality of remote devices located outside the entertainment venue, according to embodiments of the present disclosure;

FIG. 6 is a schematic diagram of one or more wearable devices disposed in the entertainment venue of FIG. 3, the entertainment venue further including one or more access points and other sensors for tracking locations and/or orientations of the wearable devices within the entertainment venue, in accordance with an aspect of the present disclosure; and

FIG. 7 is a process flow diagram illustrating a method of determining a location and/or an orientation of a plurality of devices disposed in the entertainment venue(s) of any of FIG. 1-6, according to embodiments of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates generally to embodiments of an entertainment venue, such as a theme park environment, amusement park, and/or similar venues, and more specifically to a remote rendering system configured to communicate with one or more devices within the entertainment venue, a private network (e.g., a private wireless network, a private wireless 5G network, etc.) configured, for example, to communicatively couple various such devices with the remote rendering system, and a device localization system configured to determine locations and/or orientations of such devices. The remote rendering system may include at least one server remote from the entertainment venue or from one or more devices at the entertainment venue, where the at least one server is configured to perform various rendering tasks (e.g., generating virtual reality or augmented reality imagery, generating control signals for controlling the one or more devices, such as a movement of the one or more devices, performing a computer vision task, performing an Artificial Intelligence task, etc.) for the one or more devices at the entertainment venue. In some embodiments, such rendering tasks may be based, for example, on a location and/or orientation of the one or more devices, where the location and/or the orientation of the one or more devices is determined by the device localization system, later described in greater detail. The one or more devices may include, for example, a smartphone, a tablet, a wearable device (e.g., smart glasses, HMDs, and the like), a drone, an automated guided vehicle (AGV), etc. provided by the entertainment venue or brought by a guest to the entertainment venue. While certain processing or other computational tasks, such as edge processing tasks, may be performed by the one or more devices, heavy or more compute-intensive processing or tasks may be performed by the server(s) of the remote rendering system, shifting computational burdens away from the devices and/or the entertainment venue. In this way, large processing units and corresponding hardware componentry (e.g., batteries) may be excluded from the one or more devices, thereby reducing a size and/or weight of the one or more devices, and/or may be excluded from the entertainment venue, thereby freeing critical space at the entertainment venue. In some embodiments, the one or more devices may be communicatively coupled with the server(s) of the remote rendering system via a private network (e.g., private 5G network) of the entertainment venue in order to facilitate the above-described remote rendering features.

As an example of the above-described features, the entertainment venue may include one or more drones configured to display content (e.g., artificial reality, virtual reality, and the like) to entertain guests. In traditional configurations, the drones may include complex onboard processing hardware and large batteries configured to render the content, thus hindering a movability of the drones due to the weight of the onboard processing hardware and batteries. According to the present disclosure, the remote rendering system enables smaller processing units of the one or more drones by shifting certain computational tasks onto the server(s) of the remote rendering system, enabling the one or more drones to be lighter in weight and prioritize edge processing tasks like maneuvering around guests. As another example, the entertainment venue may include one or more wearable devices, such as virtual reality (VR) or augmented reality (AR) glasses or goggles, which may be fit with relatively small processing units compared to traditional configurations by shifting computational burdens to the server(s) (e.g., including graphics processing unit or GPU clusters) of the remote rendering system, thereby improving a comfort and/or immersive experience of guests donning the one or more wearable devices.

The entertainment venue also may include a device localization system, as previously described, generally configured to determine a location and/or an orientation of the one or more devices (e.g., the smartphone, the tablet, the wearable device, the drone, etc.) with a higher accuracy and/or precision than traditional configurations, with a lower computational burden than traditional configurations, or both. As described in greater detail with reference to later drawings, the device localization technique may employ a variety of different localization techniques to determine the location(s) and/or orientation(s) of the one or more devices. For example, the device localization system may employ a first technique to determine a general location and/or a general orientation of a particular device, and then a second technique to determine, within the general location and/or the general orientation, a more specific location and/or a more specific orientation of the particular device. In some embodiments, three or more localization techniques may be employed, where each successive localization technique becomes more precise and/or accurate than the last. By employing multiple localization techniques in series, as described above, computational burdens associated with the device localization system may be reduced relative to traditional configurations. As an example, certain localization techniques – if performed without context from prior localization techniques – may require excessive computation based on processing of data that would otherwise be excludable if the prior localization technique had already been performed. By performing the first localization technique, which may be a relatively low computation localization technique, to exclude certain data prior to performing the second localization technique, which traditionally may be a relatively high computation localization technique, the excluded data may reduce an amount of computation required in the second localization technique, thereby reducing a total computation or processing burden relative to traditional configurations. As described in detail with reference to the drawings, the device localization system may include a variety of componentry, such as one or more processing units, one or more access points, one or more sensors, and the like disposed throughout the entertainment venue and employed in the various localization techniques briefly mentioned above. These and other aspects of the present disclosure are described in detail below with reference to the drawings.

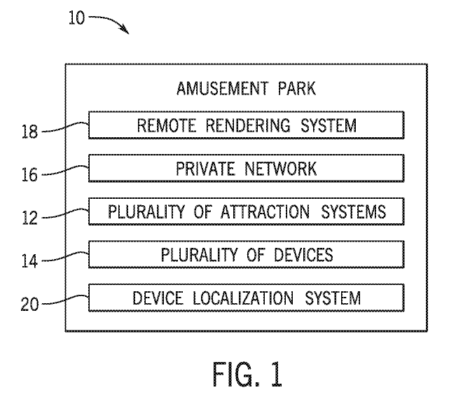

Turning now to the drawings, FIG. 1 is a block diagram of an entertainment venue 10 including a plurality of attraction systems 12 and a plurality of devices 14 provided by the entertainment venue 10 and/or brought by a guest to the entertainment venue 10. While the entertainment venue 10 is referred to in certain instances of the present disclosure below as an amusement park (e.g., amusement park 10), it should be understood that other types of entertainment venues are also possible, such as a theater, a concert hall, etc.

In the illustrated embodiment, the plurality of attraction systems 12 (e.g., a roller coaster, an amusement ride, an interactive show, an immersive experience, etc.) may be operable to entertain one or more guests. For example, the plurality of attraction systems 12 may include a ride vehicle configured to carry passengers (e.g., guests of the amusement park) through the plurality of attraction systems 12. As earlier mentioned, the plurality of devices 14 may include smartphones, tablets, wearable devices (e.g., smart glasses, head mounted displays (HMDs), virtual, augmented, and/or extended reality headsets, and the like), drones, AGVs, and the like that may also be operable to entertain the one or more guests. In some embodiments, the guests may be wearing the wearable devices while on a ride vehicle of the plurality of attraction systems 12.

The amusement park 10 also may include a private network 16 (e.g., a private wireless network, such as a private 5G network, also referred to as a standalone network) to which the plurality of attraction systems 12 and the plurality of devices 14, among other componentry, may connect. The private network 16, for example, may correspond to a network built and operated by the amusement park 10, as opposed to a network built and operated by a separate entity. The plurality of devices 14 brought to the amusement park 10 by the guests may seamlessly connect to the private network 16 upon entering the amusement park 10 (e.g., following user consent), and/or an operator of the amusement park 10 may wirelessly connect the plurality of devices 14 provided by the amusement park 10 to the private network 16. The private network 16 may be a private 5G network that is secure and exclusive, while also improving mobility, jitter control, and the like. The private network 16 may include one or more antennas disposed throughout the amusement park 10 to ensure a stable connection between the private network 16 and the plurality of devices 14 and the plurality of attraction systems 12, among other possible componentry, such as remote rendering servers (e.g., including graphics processing unit or GPU clusters) described in greater detail below.

The amusement park 10 may also include a remote rendering system 18 including one or more remote servers configured to wirelessly connect to the private network 16. The remote rendering system 18 may be configured to shift heavy computational and/or processing tasks from the plurality of devices 14 to the one or more remote servers. The heavy computational and/or processing tasks may include processing high-quality graphics, virtual reality (VR) graphics, augmented reality (AR) graphics, mixed reality (MR) graphics, and/or extended reality (XR) graphics, decision making, Artificial Intelligence (AI) processing, device localization processing, controls processing, and the like. Thus, the remote rendering system 18 may eliminate a need for heavy onboard processing hardware and large batteries provided on the plurality of devices 14, enabling the plurality of devices 14 to be more compact (e.g., smaller), longer-lasting, and prioritize lower computational processing tasks (e.g., edge computing), without compromising the guests’ experience. The remote rendering system 18 also may enable guests to bring their own devices, that typically include onboard hardware configured for low computational tasks, to the amusement park 10 and engage with the plurality of attraction systems 12 by processing the heavy computational processing tasks required to provide high quality content associated with the plurality of attraction systems 12. Such remote rendering techniques may also reduce an overheating of the plurality of devices 14 by way of the reduced computational burdens at the plurality of devices 14. It should be understood, however, that the plurality of devices 14 may still perform certain edge processing tasks separate from the server(s) of the remote rendering system 18.

Additionally or alternatively, the remote rendering system 18 and private network 16 may enable guests to access immersive XR experiences on their own devices 14 without the need for advanced hardware. The guests may then experience seamless, interactive VR, AR, MR, and/or XR content across the plurality of attraction systems 12, like interactive queue line shows or augmented reality (AR) experiences within themed rides, among other possible iterations. The centralized processing approach reduces costs and enhances the scalability of deploying advanced VR, AR, MR, and/or XR experiences throughout the amusement park 10, creating a cohesive, immersive, and engaging guest experience.

The remote rendering system 18 and the plurality of devices 14 may connect to the private network 16, and the private network 16 may enable the remote rendering system 18 and the plurality of devices 14 to transfer data packages, information, and the like between each other seamlessly and securely. For example, the remote rendering system 18 may receive data associated with graphics rendering from the plurality of devices 14, the locations of the plurality of devices 14, and/or the orientations of the plurality of devices 14 via the private network 16, and the plurality of devices 14 may receive graphics instructions from the remote rendering system 18 via the private network 16. The remote rendering system 18 and the private network 16 may then enable simpler, more lightweight devices to be deployed in the amusement park 10, while delivering high-fidelity content that would typically require more powerful onboard processing at the plurality of devices 14. The remote rendering system 18 and the private network 16 may also improve the guests experience with the plurality of devices 14 at the amusement park 10 by minimizing motion sickness, maintaining real-time interactivity, stabilizing and/or smoothing visual experiences, enhancing user comfort, and the like. Although the remote rendering system 18 may handle graphics rendering for the plurality of devices 14, the remote rendering system 18 may handle any heavy computational tasks traditionally performed by the plurality of devices 14.

In some embodiments, the remote rendering system 18 may render precise high-quality graphics for the plurality of devices 14 based on location and/or orientation data of the plurality of devices 14. However, the amusement park 10 may include a dynamic environment that may obstruct typical location tracking methods employed on the plurality of devices 14. Additionally or alternatively, typical location tracking methods may be computationally burdensome. Accordingly, the amusement park 10 may include a device localization system 20, which may be connected to the private network 16, configured to determine a location and/or orientation of the plurality of devices 14. The device localization system 20 may initially determine a region of the amusement park 10 that a device of the plurality of devices 14 is located within (e.g., via a first localization technique), and then employ additional tracking features (e.g., via a second localization technique) to further narrow the location and/or orientation of the device of the plurality of devices 14 within the region of the amusement park 10. As an example, the first localization technique (e.g., a relatively low compute localization technique) may be employed to exclude certain data from being processed and/or analyzed by the second localization technique (e.g., a relatively high compute localization technique), thereby reducing a total computational load in determining the location of the device of the plurality of devices 14. In some embodiments, the above-described techniques are also employed to determine a general orientation and then a more specific orientation of the device(s). Additionally or alternatively, in some embodiments, the remote rendering system 18 may then receive the location and/or orientation data associated with the device of the plurality of devices 14 from the device localization system 20 via the private network 16. The remote rendering system 18 may then provide precise graphics to the plurality of devices 14, thus improving the guests’ experience at the amusement park 10. In other embodiments or conditions, the device of the plurality of devices 14 itself may receive the location data for performing on-board processing (e.g., edge processing) tasks.

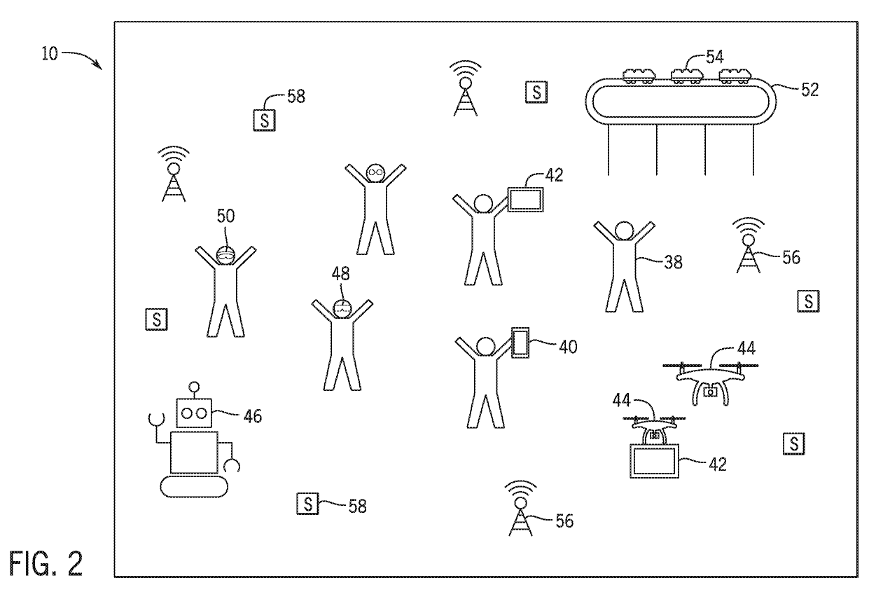

FIG. 2 is a perspective view of the entertainment venue, such as the amusement park 10, of FIG. 1, including various examples of the plurality of devices 14 from FIG. 1 therein. While element number 14 is not provided in FIG. 2, it is provided in FIG. 1, and it should be understood that at least some of the devices described in detail below correspond to the plurality of devices 14 in FIG. 1.

As previously mentioned, the amusement park 10 may include a plurality of guests 38 that may engage with the plurality of devices 14 and the plurality of attraction systems 12. The plurality of devices 14 from FIG. 1 may include, as shown in FIG. 2, one or more smartphones 40, one or more tablets 42, one or more drones 44, one or more automated guided vehicles (AGVS) 46 or robots, one or more wearable devices like smart glasses 48 or HMDs 50, and the like. As earlier mentioned, the plurality of devices 14 may be provided by the amusement park 10 or brought by the plurality of guests 38 to the amusement park 10. The plurality of guests 38 may travel throughout the amusement park 10 with the plurality of the devices 14. Additionally, the plurality of attraction systems 12 may include one or more roller coasters 52, one or more ride vehicles 54, and the like configured to carry the plurality of guests 38 throughout the plurality of attraction systems 12. In some embodiments, the plurality of attraction systems 12 may include an interactive theme ride that requires the plurality of guests 38 to use the plurality of devices 14 throughout the ride. In other embodiments, the plurality of attraction systems 12 may include an interactive queue line that shows VR, AR, MR, or XR experiences (e.g., imagery) within theme rides.

As earlier described, the plurality of devices 14 may connect to the private network 16 at the amusement park 10. In some embodiments, the private network 16 is enabled, for example, at least in part by communication towers at the amusement park 10 and is not accessible by devices outside of the amusement park 10 (e.g., by way of a geofence, by way of a limitation on a range of the private network 16, etc.) and/or by devices on a wireless spectrum different than a park wireless spectrum (e.g., licensed spectrum) associated with the private network 16 and dedicated to the amusement park 10. The remote rendering system 18 may also be connected to the private network 16, enabling the remote rendering system 18 and the plurality of devices 14 to communicate via the private network 16. For example, the plurality of devices 14 may send data or signals (e.g., requests, location data, etc.) associated with high computational processing tasks to the remote rendering system 18 via the private network 16. The remote rendering system 18 then may process the high computational processing tasks and transmit an associated output to the plurality of devices 14 via the private network 16.

In order for the remote rendering system 18 to deliver the high quality graphics to the plurality of devices, the device localization system 20 may determine a precise location of the plurality of devices 14 within the amusement park 10. Accordingly, the amusement park 10 may include one or more access points 56 and one or more sensors 58 disposed throughout the amusement park 10. The one or more access points 56 and the one or more sensors 58 may be connected to the private network 16. The one or more access points 56 and the one or more sensors 58 also may be configured as antennas to maintain a connection between the plurality of devices 14 and plurality of attraction systems 12 and the private network 16.

As a non-limiting example, as the plurality of devices 14 moves throughout the amusement park 10, the plurality of devices 14 may transmit probe signals to search for nearby access points 56 or sensors 58. After the nearby access points 56 or sensors 58 receive the probe signals, the nearby access points 56 or sensors 58 may transmit signals to the plurality of devices 14. The device localization system 20 may analyze characteristics of the signals to determine a region of the amusement park 10 that the plurality of devices 14 are located within. The device localization system 20 may then implement additional tracking features to narrow the location and/or orientation data of the plurality of devices 14 within the region of the amusement park 10. In some embodiments, at least a portion of the device localization system 20 may be implemented within the plurality of devices 14. The remote rendering system 18 may then receive the location data associated with the plurality of devices 14 to deliver high quality graphics to the plurality of devices 14 via the private network 16.

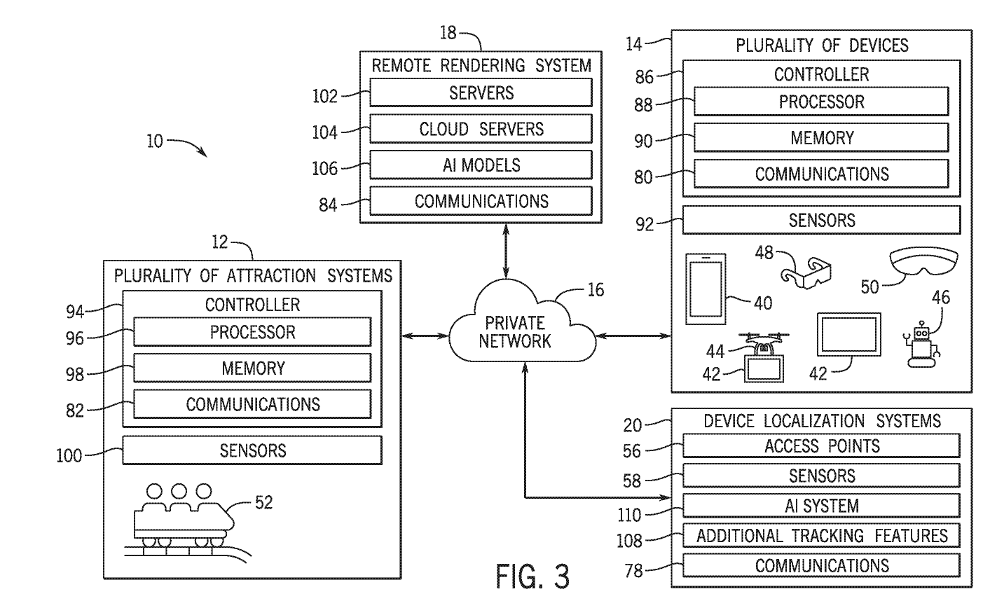

FIG. 3 is schematic diagram of the entertainment venue, such as the amusement park 10 of FIG. 1, illustrating a communication assembly between the remote rendering system 18, the device localization system 20, the plurality of devices 14, the plurality of attraction systems 12, and the private network 16. As shown, the remote rendering system 18, the device localization system 20, the plurality of devices 14, and/or the plurality of attraction systems 12 may connect to the private network 16, enabling signal and/or data transfer between each other via the private network 16. As shown, the device localization system 20 may include a communications component 78 (e.g., a transmitter, a receiver, and/or a transceiver), the plurality of devices 14 may include a communications component 80 (e.g., a transmitter, a receiver, and/or a transceiver), the plurality of attraction systems 12 may include a communications component 82 (e.g., a transmitter, a receiver, and/or a transceiver), and the remote rendering system 18 may include a communications component 84 (e.g., a transmitter, a receiver, and/or a transceiver) configured to transmit and/or receive data to and from the private network 16, which itself may include one or more servers, one or more communication components, etc. As previously described, the private network 16 may provide secure and reliable data transfer between the various components (e.g., the device localization system 20, the plurality of devices 14, the plurality of attraction systems 12, and/or the remote rendering system 18) of the amusement park 10. In some embodiments, the various components of the amusement park 10 may encode data before transmitting to the encoded data via the private network 16, and the various components may decode the data received via the private network 16.

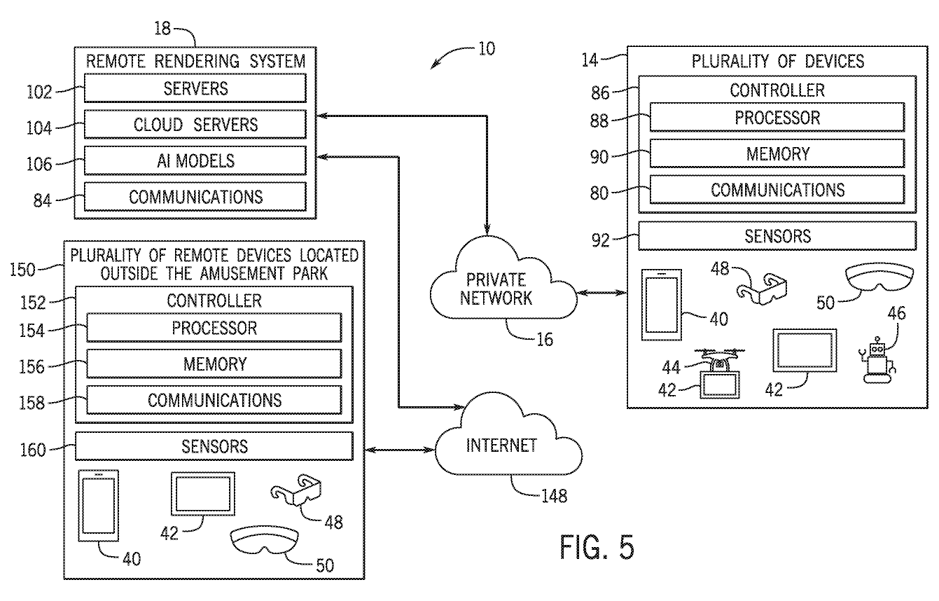

As illustrated, the plurality of devices 14 may include a controller 86 that controls at least some of the plurality of devices 14. The controller 86 may include a processor 88, a memory 90, the communications component 80, and instructions stored on the memory 90 and executable by the processor 88 to operate the plurality of devices 14 according to the associated theme park experience. In some embodiments, each device of the plurality of devices 14 includes its own instance of the controller 86. As earlier described, the plurality of devices 14 may provide the plurality of guests with XR content, VR content, AR content, MR content, and the like. The communications component 80 of the controller 86 may receive interactive data from the guest or devices of the guest. For example, the plurality of devices 14 may enable the guests to engage in interactive content being displayed on a screen of the plurality of devices 14. The plurality of devices 14 may transmit data to the remote rendering system 18 including the guests’ interaction via the private network 16. In some embodiments, one or more sensors 92 of the plurality of devices 14, as shown, or separate from the plurality of devices 14 are configured to capture real-world data (e.g., imagery) used to determine a location and/or orientation of the plurality of devices 14 within the amusement park 10. The one or more sensors 92 may include, for example, a camera, a gyroscope, an accelerometer, an Inertial Measurement Sensor (IMU), a Global Navigation Satellite Systems (GNSS) sensor, an Infrared sensor, a Light Detection and Ranging (LiDAR) sensor, some other type of sensor, or any combination thereof. It should be noted that, in some embodiments, at least a portion of the one or more sensors 92 may overlap with at least an additional portion of earlier described sensors, such as the sensors 58 in FIG. 2, or later described sensors, such as the sensors 100 in FIG. 3, the sensors 160 in FIG. 5, or any other sensor in presently disclosed embodiments. In general, the one or more sensors 92 may transmit the real-world data and/or the location and/or orientation data of the plurality of devices 14 to the controller 86 of the plurality of devices 14 via the communications component 80. The controller 86 may then be able to provide the guests with an immersive experience based on the real-world data and/or the location and/or orientation data.

Similarly, the plurality of attraction systems 12 may also include a controller 94 having a processor 96, a memory 98, the communications component 82, and instructions stored on the memory 98 and executable by the processor 96 to operate the plurality of attraction systems 12 according to the associated theme park experience. The plurality of attraction systems 12 also may include one or more sensors 100 to capture real-world data, determine a location of the plurality of attraction systems 12, safety monitoring, and the like. The one or more sensors 100 may transmit collected data to the communication component 82 of the plurality of attraction systems 12, thus, the controller 94 may operate the plurality of attraction systems 12 based on the data from the one or more sensors 100. As described above, the plurality of attraction systems 12 may include AR, VR, MR, and/or XR elements that may enable the plurality of guests to interact with the ride attraction via the plurality of devices 14 while riding the plurality of attraction systems 12. Accordingly, the communications component 80 of the plurality of devices 14 may send interaction data to the communications component 82 of the plurality of attraction systems 12 via the private network 16. The controller 94 may then operate the plurality of attraction systems 12 according to the interaction data.

According to certain embodiments of the present disclosure, in order to provide the plurality of guests with a more immersive experience, the remote rendering system 18 may receive heavy computational processing tasks (or requests therefor) from the plurality of devices 14 and/or the plurality of attraction systems 12 associated, for example, with graphics rendering via the private network 16, among other possible computational tasks. For example, the plurality of devices 14 and the plurality of attraction systems 12 may deliver AR content, VR content, MR content, and/or XR content to the plurality of guests. However, graphics rendering associated with the AR content, VR content, MR content, and/or XR content may require high computational power that may not be provided by the plurality of devices 14 and the plurality of attraction systems 12, may lower a battery life of the plurality of devices 14, and/or may require bulky equipment at the plurality of devices 14 if performed by the plurality of devices 14, such as wearable devices provided by the amusement park 10 or brought by the guests to the amusement park 10. Thus, the remote rendering system 18 may include one or more servers 102 (e.g., on-site servers, including for example graphics processing unit or GPU clusters at the amusement park 10), one or more cloud servers 104, or a combination thereof to process the heavy computational processing tasks of the plurality of devices 14 and the plurality of attraction systems 12. The one or more servers 102, the one or more cloud servers 104, or a combination thereof may be remote from plurality of devices 14 and/or the attraction systems 12 but located elsewhere at the amusement park 10, remote from the amusement park 10 entirely, or a combination thereof. For example, the one or more servers 102 (e.g., on-site servers) may be included in the amusement park 10 in certain embodiments and the one or more cloud servers 104 may be included external from the amusement park 10 in certain embodiments. The one or more servers 102 and the one or more cloud servers 104 may shift the heavy computational tasks away from the plurality of devices 14 and the plurality of attraction systems 12, as previously described and described in greater detail below.

Additionally or alternatively, the remote rendering system 18 may enable the one or more drones 44 to present richer, more immersive, and dynamic visual content to the plurality of guests that was otherwise unattainable in traditional configurations due to the hardware limitations of the one or more drones 44. That is, since traditional configurations may include limited onboard computing hardware that focused on providing visual content to the plurality of guests while maneuvering in the air and around the plurality of guests, traditional configurations may be unable to provide the highest quality content to the plurality of guests (e.g., as compared to the remote rendering system 18). In this way, the remote rendering system 18 may also enable the one or more drones 44 to carry high-fidelity display screens (e.g., smartphones 40, tablets 42, etc.) that render real-time interactions with the plurality of guests. As earlier mentioned, the one or more drones 44 may include the communications component 80 that may receive interactive data from the plurality of guests (or devices 14 corresponding thereto) and transmit the interactive data to the remote rendering system 18 via the private network 16. Thus, the remote rendering system 18 and the private network 16 may improve data transfer between various components (e.g., plurality of devices 14, plurality of attraction systems 12, etc.) of the amusement park 10 and reduce an overall cost and complexity of the plurality of devices 14 disposed throughout the amusement park 10.

As another example, the amusement park 10 may include automated devices such as automated drones 44, the AGVs 46, and the like. The remote rendering system 18 may perform artificial intelligence (AI) tasks and training of one or more AI models 106 of the automated devices, enabling the automated devices to process simpler tasks at the edge (e.g., edge processing tasks). The edge processing tasks may include real-time, low latency tasks, such as computer vision processing, interacting with the plurality of guests, and collecting data pertaining to behavior and preferences of the plurality of guests. The computer vision processing may include object detection, object avoidance, motion control in certain embodiments, and/or basic decision making required for environment navigation. That is, the automated (e.g., AI) drones 44 and/or the AGVs 46 may include the one or more sensors 92 (e.g., cameras, LiDAR, etc.) that captures images and videos of the real-world environment (e.g., the amusement park 10), and the automated drones and the AGVs 46 may then recognize obstacles and guest gestures and adjust their path and behavior in real-time without requiring remote server input. In some embodiments, the captured imagery of the real-world environment also may be employed by the device localization system 20 to determine a location and/or orientation of the AGVs 46 or other devices 14 at the amusement park 10, as previously described. Additionally or alternatively, in some embodiments, the device localization system 20 may be at least partially integrated with the remote rendering system 18, such that at least some computational tasks associated with localizing the devices 14 is performed remote from the devices 14 themselves. In general, the remote rendering system 18 may enable the automated drones 44 and/or the AGVs 46, among other movable components corresponding to the plurality of device 14, to improve response times and operate more efficiently, while providing richer, more immersive, and interactive visual content to the plurality of guests.

By transferring heavy processing tasks, such as AI tasks, data mining, and training of the AI models 106 to the remote rendering system 18, the automated drones 44 and/or the AGVs 46 may provide personalized experiences to the plurality of guests by adapting to the dynamic environment of the amusement park 10 while autonomously interacting with the plurality of guests in real time. For example, the remote rendering system 18 may store the AI models 106 associated with an operation of the automated drones and the AGVs 46, process the large amounts of data required to train and update the AI models 106, recognize patterns, and/or make control decisions, as previously described. Additionally or alternatively, the AI models 106 may be associated with the predicted behavior and personalization of the plurality of guests (e.g., in some embodiments, the AI models 106 may determine or inform control actions based on predicted behaviors ascertained by the AI models 106). In some embodiments, the automated drones 44 and AGVs 46 (or other devices 14) may collect data (e.g., via the sensors 92) of the guests and/or the real-world environment. The remote rendering system 18 may then recognize patterns associated with the behavior and preferences of the plurality of guests and develop (e.g., train) the AI models 106 to determine and/or inform certain control actions, render certain imagery displayable by the plurality of devices 14, etc. The behavior of the plurality of guests may include interactions with the automated drones 44 and the AGVs 46, among other possible devices 14, movement throughout the amusement park 10, and the like. The AI models 106 may then be continuously updated from the data collected by devices 14. In some embodiments, the remote rendering system 18 may update the AI models 106 after a certain period of time, after a certain amount of data collected, and the like. Additionally or alternatively, in this way, the remote rendering system 18 may store all the data collected to develop the AI models 106 (e.g., as compared to deleting data to create storage for the devices 14). In some embodiments, all or some of the plurality of devices 14 and all or some of the plurality of attraction systems 12 disposed at the amusement park 10 may collect behavior and preference data pertaining to the plurality of guests.

In order to provide precise graphics rendering (e.g., AR, VR, MR, XR content) to the plurality of devices 14, a location and/or orientation of the plurality of devices 14 in the amusement park 10 may be provided to the remote rendering system 18. As such, the amusement park 10 may include the device localization system 20 to at least partially determine and/or transmit a location and/or orientation of the plurality of devices 14 to the remote rendering system 18 via the private network 16. The device localization system 20 may include the plurality of access points 56 and the plurality of sensors 58 disposed throughout the amusement park 10, as previously described, and employable in a variety of device localization techniques to determine, for example, a region of the amusement park 10 that the plurality of devices 14 are located within and then a more particular location within the region. For example, a first localization technique, such as a Global Navigation Satellite System (GNSS) technique, may be employed to determine the region and/or a general orientation, and then the device localization system 20 may employ additional tracking features 108 (e.g., computer vision techniques, access point connectivity techniques, LiDAR and/or infrared techniques, etc.) to determine a precise location of the plurality of devices 14 within the region and/or a precise orientation within the general orientation. As previously described, the first localization technique may be a relatively low compute technique configured to exclude data employed in the second localization technique, and the second localization technique may be a relatively high compute technique. As one non-limiting example, by determining the general region in which a particular device 14 is disposed via the first localization technique (e.g., via an access point connection technique and/or a GNSS technique), other regions may be excluded from consideration in the second localization technique (e.g., a computer vision technique), thereby reducing a computational load of the second localization technique relative to traditional configurations. In the above-described non-limiting example, certain imagery may be excluded based on the first localization technique (e.g., the access point connection technique and/or the GNSS technique) when employing the second localization technique (e.g., computer vision technique). It should be understood that other iterations of the first and second localization techniques are also possible. Further, it should be understood that more than two localization techniques may be employed in certain embodiments, and that such localization may include a variety of combinations of the localization techniques (e.g., GNSS, computer vision, access point connectivity, LiDAR, infrared, movement pattern techniques, etc.) described in the present disclosure.

In some embodiments, the additional tracking features 108 (e.g., the second localization technique, the third localization technique, etc.) may include and/or interact with an AI system 110, which may be the same as or different from or interact with the AI models 106 of the remote rendering system 18, that may determine or predict the movement patterns of the plurality of guests (e.g., via gyroscope data from a gyroscope sensor, accelerometer data from an accelerometer sensor, etc.) within the plurality of attraction systems 12 and within the amusement park 10. As earlier described, the AI models 106 stored on the remote rendering system 18 may pertain to the behavior (e.g., movement) and preferences of the plurality of guests in the amusement park 10 and the plurality of attraction systems 12. In some embodiments, the device localization system 20 may transmit the region of the amusement park 10 that the plurality of devices 14 are located within and required data pertaining to the plurality of devices 14 to the remote rendering system 18 via the private network 16. The remote rendering system 18 may then use the AI models 106 and the transmitted data to determine a precise location of the plurality of devices 14. The remote rendering system 18 may then transmit the precise location of the plurality of devices 14 to the device localization system 20 via the private network 16.

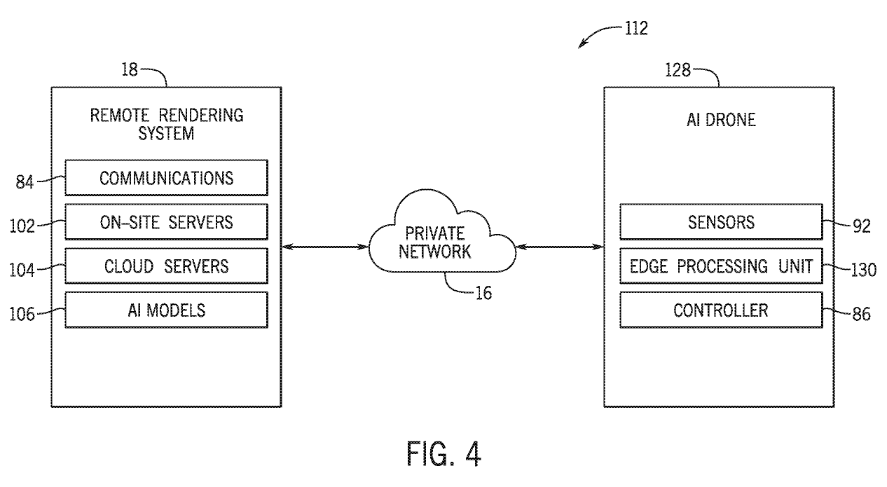

FIG. 4 is a schematic diagram of an embodiment of a processing and communication assembly 112 of any of the entertainment venues (e.g., amusement parks) FIGS. 1-3. In the illustrated embodiment, an AI drone 128 (or automated drone) may be implemented within the amusement park 10, although other types of devices (e.g., tablets, smartphones, wearable devices, etc.) are also possible in accordance with the present disclosure. As earlier described, the AI drone 128 may include sensors 92 (e.g., cameras, LIDAR, GPS) that collect real-time environmental data, or behavioral and preference data of the plurality of guests, or other data, or any combination thereof. The controller 86 may then transmit such data to the remote rendering system 18 via the communications component 80 of the AI drone 128 and the private network 16. The private network 16 may include a wireless communication link between the AI drone 128 and the remote rendering system 18, as previously mentioned. The remote rendering system 18 may then receive the data from the AI drone 128 (or other device) at the communications component 84 via the private network 16. The remote rendering system 18 may then utilize the on-site servers 102, the cloud servers 104, or a combination of both to develop and/or execute AI models 106 pertaining to the behavior and preferences of the plurality of guests, the location and/or orientation of the AI drone 128 (or other devices), the remote rendering tasks request by the AI drone 128 (or other devices), or the like. The remote rendering system 18 also may use the one or more servers 102, 104 to process heavy computational tasks of the AI drone 128 (or other devices) and transmit instructions, graphics or content (e.g., VR, AR, MR, XR graphics or other content), or the like to the AI drone 128 via the private network 16. In some embodiments, the AI drone 128 may include an edge processing unit 130 that focuses on real-time, low-latency tasks, such as processing sensor data from the one or more sensors 92 for real-time navigation (e.g., obstacle detection, path planning, immediate decision-making, etc.), while the remote rendering system 18 performs more heavy computational tasks, such as the above-described graphics or content rendering tasks.

FIG. 5 is a schematic diagram of an embodiment of the entertainment venue, such as the amusement park 10, including an Internet network 148 separate from the private network 16 and connected to the remote rendering system 18 and a plurality of remote devices 150 (e.g., one or more guest devices) located outside the amusement park 10. For example, while certain aspects of the present disclosure include the private network 16 at the amusement park 10 and various localization and/or rendering techniques facilitated by the private network 16 with respect to the devices 14 at the amusement park 10, additional or alternate aspects of the present disclosure may include the Internet network 148 separate from the private network 16 and various rendering techniques facilitated by the Internet network 148 with respect to the remote devices 150 away from the amusement park 10. As described in detail below, the devices 14 at the amusement park 10 and the remote devices 150 away from the amusement park 10 may be the same devices at different time intervals. That is, the features described herein and described in detail below may enable an extension of the experience at the amusement park 10 to remote locations, for example, before the guests arrive at the amusement park 10 and/or after the guests leave the amusement park 10.

As shown, the plurality of remote devices 150 (or some other aspect of the system) may include a controller 152 having a processor 154, a memory 156, a communications component 158, and instructions stored on the memory 156 and executable by the processor 154 to operate the plurality of remote devices 150 located outside the amusement park 10 to provide the extended experiences described above. Although the plurality of remote devices 150 is located outside the boundaries of the amusement park 10 (e.g., before the remote devices 150 reach the park or after the remote devices 150 exit the park), the remote rendering system 18 may enable at least limited AR, VR, MR, and/or XR interactivity (or other graphics and/or content rendering) with the plurality of remote devices 150 possessed by the plurality of guests. The plurality of remote devices 150 may be communicatively coupled with the remote rendering system 18 (or some other graphics or content system associated with the amusement park 10) via the Internet network 148. The plurality of remote devices 150 also may include one or more sensors 160 that may collect data about the real-world environment outside the amusement park 10 (e.g., adjacent to the remote device 150) and send the data to the remote rendering system 18 (or other system) via the Internet network 148. The remote rendering system 18 may also connect to the Internet network 148 to transmit graphics or other content to the plurality of remote devices 150. In some embodiments, the plurality of guests located outside the boundaries of the amusement park 10 may interact with the plurality of remote devices 150, and the interactive data collected by the processor 154 of the plurality of remote devices 150 may be transmitted by the communication component 158 of the plurality of remote devices 150 to the remote rendering system 18.

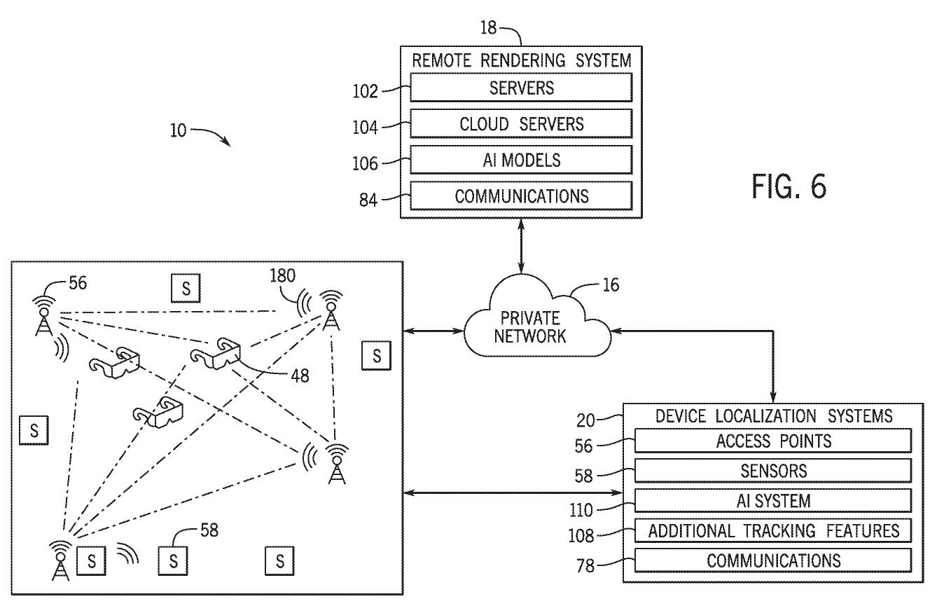

FIG. 6 is a schematic diagram of one or more wearable devices (e.g., smart glasses 48, HMDs 50) disposed in the amusement park 10 and configured to communicate with the device localization system 20 via the private network 16. As described earlier, the remote rendering system 18 may render high-quality graphics for AR, VR, MR, and/or XR content delivered on wearable devices based on the location and/or orientation data of the wearable devices within the amusement park 10.

In some embodiments, the device localization system 20 may employ a series of techniques to determine the location and/or orientation of the wearable device. The series of techniques may increase a precision and/or accuracy of the location and/or orientation data than the previous technique. By employing the techniques in series, the computational burdens associated with the device localization system 20 may be reduced. As described earlier, a first localization technique, which may be a relatively low computation localization technique, may be performed to determine a general location and/or general orientation of a wearable device in the amusement park 10, and a second localization technique, which may be a relatively heavy computation localization technique, may be performed to determine a more precise location and/or general orientation of the wearable device within the general location and/or general orientation. The general location and/or general orientation determined by the first localization technique may exclude certain data prior to performing the second localization technique, reducing an amount of computation required by the second localization technique.

In some embodiments, the first localization technique employed by the device localization system 20 may be an access point connection technique and/or a GNSS technique to initially determine a region of the amusement park 10 that a wearable device (e.g., smart glasses 48) is located. To employ the access point connection technique, the device localization system 20 may include the one or more access points 56 and the one or more sensors 58. For example, the access points 56 and the sensors 58 may transmit signals 180 to the smart glasses 48, and the device localization system 20, which may be at least partially stored on or separate from the smart glasses 48, may determine characteristics of the signals 180 to determine the region of the amusement park 10 that the device is located within. That is, the device localization system 20 may determine which access points and sensors of the access points 56 and sensors 58 within the amusement park 10 transmitted the signals 180 to the smart glasses 48. The device localization system 20 may then analyze a signal strength, a signal angle (e.g., relative to the device), a time of flight, an identifier of the specific access point 56 corresponding to the signal, and/or some other characteristic associated with the signal to locate a region and/or an orientation of the smart glasses 48 within the amusement park 10. The GNSS technique employed by the device localization system 20 may provide the remote rendering system 18 with additional tracking information by measuring time delays of signals transmitted from the smart glasses 48 to one or more satellites.

The device localization system 20 may then employ additional tracking features 108 (e.g., a second localization technique) to determine a precise location of the smart glasses 48 within the amusement park 10. The additional tracking features 108 may include the IMUs, Depth Sensors, signal techniques described above, computer vision techniques, LiDAR, Infrared, etc. The IMUs provide tracking of the orientation of the smart glasses 48, while also capturing minor movements of the user by capturing acceleration and rotation data. The acceleration and rotation data may then be sent to the remote rendering system 18 from the device localization system 20 via the private network 16. The remote rendering system 18 may then render high-quality graphics based on the acceleration and rotation data of the smart glasses 48. Additionally, the one or more sensors 92 on the smart glasses 48 may include depth sensors that are configured to measure distances to nearby surfaces using LiDAR techniques, thus developing a spatial map of the surroundings of the guest wearing the smart glasses 48. The spatial map may then be sent to the remote rendering system 18 for further processing, and the remote rendering system 18 may then process high-quality graphics for the smart glasses 48. In some embodiments, the distance to nearby surfaces may be sent to the remote rendering system 18, and the remote rendering system 18 may develop the spatial map.

Additionally, the additional tracking features 108 may include further outside-in-tracking methods and inside-out-tracking methods. That is, the one or more sensors 58 of the device localization system 20 disposed throughout the amusement park 10 may be configured as infrared base stations or cameras to provide additional position data associated with the smart glasses 48. In some embodiments, the one or more sensors 58 of the device localization system 20 may be strategically placed within the amusement park 10 to remediate deficiencies in the positional data provided by the one or more access points 56. The one or more sensors 58 of the device localization system 20 may also capture a spatial map of the user’s surroundings and transmit the spatial map to the remote rendering system 18. Further, the inside-out-tracking methods may include the smart glasses 48 capturing a spatial map of the user’s surroundings using the depth sensors 92 of the plurality of devices 14.

As mentioned earlier, the remote rendering system 18 may develop an AI model pertaining to the behavior and preferences of the plurality of guests within the amusement park 10. The remote rendering system 18 may then transmit the associated AI model of the AI models 106 (e.g., AI system 110) to the device localization system 20. The device localization system 20 may then deploy the AI model to determine a more precise location of the smart glasses 48 in response to determining the region that the smart glasses 48 are located within. The AI model may then predict a user’s (e.g., the plurality of guests 38) behavior and positioning based on the region that the smart glasses 48 are located within. The AI system 110 may also filter noise from depth sensors 92, IMUs data, and the like. By filtering out the noise, the AI system 110 may then determine valid movements of the user.

Further, the additional tracking features 108 may include collaborative methods having wearable devices (e.g., smart glasses 48) located nearby to share positional data to reinforce localization accuracy of the smart glasses 48. The positional data of the smart glasses 48 may then be corrected based on the shared position data from adjacent or nearby wearable devices. In some embodiments, the smart glasses 48 may lose signal, and the adjacent wearable devices may share positional data to the smart glasses 48 that have lost signal. Although the illustration shows determining the location for wearable devices, it should be understood that the device localization system 20 may be employed on any of the plurality of devices 14 within the amusement park 10.

After the device localization system 20 determines the position and orientation of the smart glasses 48 within the amusement park 10, the localization system 20 may send the location and orientation data to the remote rendering system 18 via the private network 16. The remote rendering system 18 may then process high-fidelity graphics content for the smart glasses 48 and transmit the high-fidelity graphics content to the smart glasses 48 for display via the private network 16.

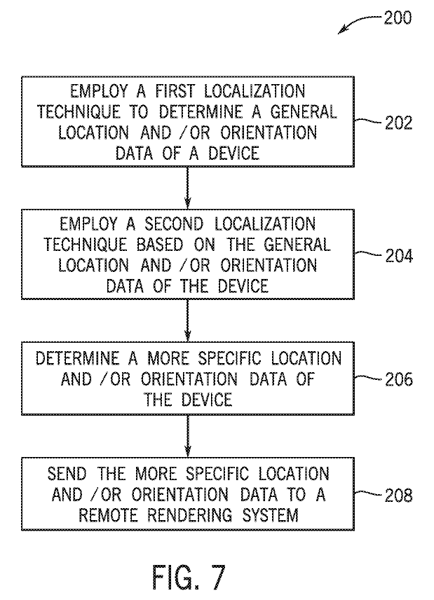

FIG. 7 is a process flow diagram illustrating an embodiment of a method 200 of determining a location and/or orientation of at least one device of the plurality of devices 14 disposed in the amusement park 10 of any of FIGS. 1-6. While certain embodiments of the method 200 may include an ordering of steps as illustrated in FIG. 7 and described in detail below, the ordering of the steps illustrated in FIG. 7 and described in detail below should not be taken as implying that all embodiments of the method 200 are performed in said order. Indeed, other orders are also possible in other embodiments of the method 200. Further, certain steps of the method 200 illustrated in FIG. 7 and described in detail below may be excluded in certain embodiments. Further still, certain steps not illustrated in FIG. 7 and/or not described in detail below may be included in certain embodiments of the method 200.

In the illustrated embodiment, the method 200 includes employing (block 202) a first localization technique to determine a general location and/or orientation data of a device within an amusement park. The first localization technique may include a relatively low computational localization technique, such as an access point connection technique and/or a GNSS technique. The method 200 also includes employing (block 204) a second localization technique based on the general location and/or orientation data of the device determined by the first localization technique. The second localization technique may include a computer vision technique, a LiDAR technique, an Infrared technique, or some other technique, trained or conditioned only on the general region and/or general orientation determined from the first localization technique. The method 200 also includes determining (block 206) a more specific location and/or orientation data of the device within the general location and/or general orientation data of the device. The method 200 also includes sending (block 208) the more specific location and/or orientation data of the device to a remote rendering system via a private network. The remote rendering system may use the precise location and/or orientation data of the device to render high-quality graphics for the plurality of devices.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-6 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A system for an entertainment venue, comprising:
a plurality of devices at the entertainment venue;
at least one server remote from the plurality of devices, the entertainment venue, or both, wherein the at least one server is configured to perform a remote rendering task; and
a private wireless network configured to facilitate data transmission between the plurality of devices and the at least one server.

2. The system of claim 1, wherein the plurality of devices comprises a smartphone, a tablet, or a wearable device.

3. The system of claim 1, wherein the plurality of devices comprises an automated guided vehicle (AGV).

4. The system of claim 1, wherein the plurality of devices comprises a drone.

5. The system of claim 1, wherein the remote rendering task comprises a remote Artificial Intelligence (AI) rendering task, a computer vision rendering task, or both.

6. The system of claim 1, wherein the remote rendering task comprises a graphics rendering task for virtual reality (VR) imagery, augmented reality (AR) imagery, mixed reality (MR) imagery, or extended reality (XR) imagery.

7. The system of claim 1, wherein the plurality of devices comprises at least one device having an edge processing unit configured to perform a real-time, low latency task.

8. The system of claim 7, wherein the real-time, low latency task comprises object detection, obstacle avoidance, environment navigation, or any combination thereof.

9. The system of claim 7, wherein the at least one device comprises a sensor, and wherein the edge processing unit is configured to perform the real-time, low latency task based at least in part on sensor data received from the sensor.

10. The system of claim 1, comprising a localization system configured to:
determine, based on a first localization technique, a region of the entertainment venue in which a device of the plurality of devices is disposed; and
determine, based on a second localization technique, a location within the region of the entertainment venue at which the device is located.

11. The system of claim 10, wherein the second localization technique comprises a computer vision technique.

12. A device localization system for an entertainment venue, the device localization system comprising:
at least one sensor configured to acquire sensor data related to a device or an environment adjacent to the device;
memory circuitry storing instructions thereon; and
processing circuitry configured to execute the instructions to:
receive the sensor data from the at least one sensor;
determine, based on a first localization technique, a region of the entertainment venue in which the device is disposed; and
determine, based on a second localization technique different from the first localization technique, a location within the region of the entertainment venue at which the device is disposed, wherein the first localization technique, the second localization technique, or both are based at least in part on the sensor data.

13. The device localization system of claim 12, wherein:
the first localization technique comprises a Global Navigation Satellite System (GNSS) technique, an access point connection technique, or both; and
the second localization technique comprises a computer vision technique.

14. The device localization system of claim 12, wherein the at least one sensor comprises a gyroscope, an accelerometer, a camera, or any combination thereof.

15. The device localization system of claim 14, wherein the processing circuitry is configured to execute the instructions to:
determine, based on the first localization technique a general orientation of the device; and
determine, based on the second localization technique, a specific orientation within the general orientation of the device.

16. The device localization system of claim 12, comprising a plurality of access points, wherein the processing circuitry is configured to execute the instructions to:
determine at least one characteristic of a signal transmitted between the device and at least one access point of the plurality of access points; and
employ the at least one characteristic in the first localization technique, the second localization technique, or both.

17. The device localization system of claim 16, wherein the at least one characteristic of the signal comprises a signal strength, a signal angle, a signal time of flight, an identifier of at least one specific access point of the plurality of access points, or any combination thereof.

18. A method of operating an entertainment venue, the method comprising:
determining, via a first localization technique implemented by a device localization system, a general region and a general orientation of a device at the entertainment venue;
determining, via a second localization technique implemented by the device localization system, a specific location of the device within the general region and a specific orientation of the device within the general orientation;
rendering, via a server remote from the device and based at least in part on the specific location and the specific orientation, graphical content; and
transmitting the graphical content from the server to the device.

19. The method of claim 18, wherein the graphical content comprises virtual reality (VR) content, augmented reality (AR) content, mixed reality (MR) content, extended reality (XR) content, or any combination thereof.

20. The method of claim 18, comprising outputting the graphical content on a display of the device.
